(19) United States
(12) Patent Application Publication
(10) Pub. No.: US 2020/0229656 A1
(43) Pub. Date: Jul. 23, 2020

(54) Soap'r-Saver

(71) Applicant: Harvey Simmons, Fountain, CO (US)

(72) Inventor: Harvey Simmons, Fountain, CO (US)

(21) Appl. No.: 16/353,672

(22) Filed: Mar. 14, 2019

Related U.S. Application Data
(60) Provisional application No. 62/794,548, filed on Jan. 18, 2019.

(51) Int. Cl. A47K 7/03; B08B 1/00

(52) U.S. Cl. CPC A47K 7/03; B08B 1/006

(57) ABSTRACT

The Soap'r-Saver is a very simple device; simply designed, simply made, and simple to use. A Consumer bath item utilizing ones favorite bar soaps that have been used until they're worn down to a piece too small to effectively use in the bath. The small pieces of soap are Saved in the Soap'r-S aver preventing the need to buy a new bar of soap, keeping the soap pieces out of landfills, Saving the Consumer Money and Saving the environment. Soft nylon mesh fabric closed on three sides, forming a pouch, measuring 6″ along the bottom length, 4″ on each end/side height, to the top closed with a soft plastic zipper, non-corrosive and smooth on the skin when you finally use your Soap'r-Saver in the bath, gently scrubbing, lathering, enjoying. Weighing only one ounce when empty, only ½″ thick/wide, but capacity to hold a lot of pieces of soap of all sizes.

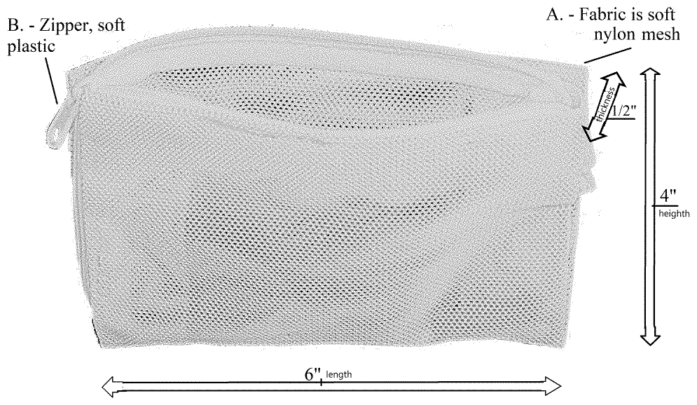

### CROSS-REFERENCE TO RELATED APPLICATIONS

Submitted in a Provisional Application, #62794548, on 18 Jan. 2019, Confirmation #8259, EFS ID #34907550.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Whereas consumers using barsoap found themselves wasting money as they would discard the barsoap when it reached a small piece that was no longer usable in the bath effectively; they would wear down the barsoap until it wore to a small piece, too small to use, then throw away that small piece thereby throwing away money, requiring the need to purchase a new bar of their favorite soap. This making for more sales to the soap manufacturers and leaving the Consumer incurring an unnecessary expense.

### BRIEF SUMMARY OF THE INVENTION

The Soap'r-Saver is a pouch where you save the small pieces of bar soap that you've used instead of throwing them away and buying a new bar.

### BRIEF DESCRIPTION OF THE SEVERAL VIEWS OF THE DRAWING

Soap'r-Saver is made from soft nylon mesh fabric, A., and a soft plastic zipper closure, B., a very simple design consisting of only two parts, the nylon mesh fabric and the zipper.

### DETAILED DESCRIPTION OF THE INVENTION

Soap'r-Saver is just the right size to use in the bath, measuring 6″ long by 4″ wide/tall, a depth/thickness of ½″ when empty, two layers of fabric closed on three sides, the fourth side closing with is non-metallic zipper to resist corrosion made of soft plastic that will not scratch the skin; comes in colors of pink, blue, green, and white. Very handy to use, simply unzip the Soap'r-Saver and drop in the small piece of soap that you've acquired through the use of your favorite bath soap. You can accumulate many pieces of soap and all different sizes of pieces, small or large; save them in your Soap'r-Saver and you're saving money.

Many people have tried many home-remedies for saving and using the small pieces of barsoap, and trying to use re-use them effectively. They've tried melting them together, only to create a hazardous mess on the stove. The Soap'r-Saver is so simplistic and easy to use. Just drop in those small pieces of used soap, then, when the Soap'r-Saver gets full of soap pieces, you can just use it as a bath washing device, lathered-up as you wet the pouch, just as a nylon latherer is used, but you have the soap inside, soaking through the mesh material, lathering and dispensing, once again, your favorite barsoaps that you've already used; and now you're re-using them again, with the money you've saved from not buying new bars of soap!

Simply unzip the Soap'r-Saver and place the small piece of bar soap inside, zip it closed and it's saved; the Soap'r-Saver will hold a lot of small soap pieces; and then, once you have saved money by saving the soap pieces in your Soap'r-Saver, you can use the Soap'r-Saver in your bath, the nylon mesh material lathers-up with the soap inside and provides a gentle, scrubbing, washing of your skin, like a wash-cloth with built-in soap, but it's your favorite soap, saved from your own soap bars, saving you money from having to buy a new soap bar.

Soap'r-Saver is for everyone, Ladies will love it since it saves money, uses their own favorite soap bar, is so gentle and lathery on their skin, a wonderful bathing experience. Men love it for saving money, and with your tough, pumice, soaps, you're saving, saving the pieces, saving money, and then you have that tough, scrubbing, pumice soap in a scrubbing cover, making it even more effective in scrubbing the grime from your hands and arms, even your face and neck, all over your body, the soft nylon mesh fabic is gently scrubbing your skin. Kids love it for it's lathering and ease of use, bathing and getting clean, more fun in the bath now, colors of blue and pink and green, Kids love it. Seniors will really love the Soap'r-Saver, saving money, not throwing away that small pieces of soap, almost like recycling, and using the Soap'r-Saver in the bath, its soft, gentle, scrubbing, lathering action on their skin; Seniors absolutely love it.

Stop throwing away money; every time you get your bath bar used down to that small piece, that's too small to use, and you just toss it in the trash and open up a new bar!

You're throwing away money!

You know it's a waste; you've tried saving those pieces and re-using them; home remedies (melting them together in a pan on the stove, etc.), that are time-consuming and dangerous, and just don't work.

Now you can Save Money and use all of that bath bar, not waste any of it, get your money's worth, with the Soap'r-Saver next time you get that bath bar used down to that small piece that's left; don't throw it away, don't throw away your hard-earned money, keeping the soap manufacturers happy, that you now have to buy another one of their bath bars; save that soap in your Soap'r-Saver; the Soap'r-Saver is made from high-quality nylon-mesh fabric, \ soft-plastic closer, no sharp edges, non-corrosive; and then, after you've Saved your bath-bar pieces, money in Your pocket, your Soap'r-Saver is the best bathing scrubber, latherer, soft nylon, gentle scrubbing, soothing, massaging, action on your skin; you'll absolutely love bathing with your Soap'r-Saver; now your favorite bathing soap, that you've saved, Money saved by you; you've now paid for your Soap'r-Saver, and it didn't even cost that much in the first place; comes in your favorite colors, powder pink, sea blue, soft green; and for the guys, when you save your favorite dirt-scrubbing soaps, like pumice, that you use to get that grease and oil and hard-working soil off your skin, you'll love the Soap'r-Saver, saving you money, and applying your favorite skin-scrubbing hand-soap, with its nylon scrubbing, and soap-lathering action, even you will feel good about saving money and using the Soap'r-Saver!

Choice of colors, powder pink, sea blue, soft green, and snow white; order Two and Save Even More; you'll want one for the Lady and one for the Man of the house; Start saving money today; stop throe g away your money with your favorite bar-soaps,

Save Your Money, Save Your Soap, with Soap'r-Saver!

1. Saves money, use all your bath bar, not throwing away the small piece because it's too small to use.
Better for the environment; keeping soap out of the landfill, using all of the bath-bar soap product instead of throwing away pieces of soap into the trash.
Enjoy your favorites bath soaps and use the Soap'r-Saver as a washing device, with its soft nylon mesh fabric, gentle scrubbing, lathering; your skin will love it.
For the traveler, the Soap'r-Saver easily passes through airport security checks, as it does not contain any liquid, just solid pieces of soap; only weighs one ounce when empty, and it's more or less just a wash cloth.
Even for the road traveler, staying in hotels a lot, using those tiny bars of soap in their showers, which are already too small to begin with; accumulate those little bars in your Soap'r-Saver, and soon you'll have a soap-filled latherer to use in the bath in a most enjoyable way.
